(19) United States
(12) Patent Application Publication
(10) Pub. No.: US 2026/0092641 A1
(43) Pub. Date: Apr. 2, 2026

(54) DUAL ARM TENSIONER WITH DYNAMIC PIVOT

(71) Applicant: GATES CORPORATION, Denver, CO (US)

(72) Inventors: David Rieland, Rochester Hills, MI (US); Patricio De La Torre, Rochester Hills, MI (US); Serge Alain Bral, Aachen (DE); Minchun Hao, Rochester Hills, MI (US)

(73) Assignee: GATES CORPORATION, Denver, CO (US)

(21) Appl. No.: 19/113,307

(22) PCT Filed: Sep. 18, 2023
(86) PCT No.: PCT/US2023/033024

§ 371 Date: Mar. 19, 2025

Related U.S. Application Data
(60) Provisional application No. 63/408,248, filed on Sep. 20, 2022.

(51) Int. Cl. F16H 7/12; F02N 11/04; F02N 15/08; F16H 7/08

(52) U.S. Cl. CPC F16H 7/1218; F02N 11/04; F02N 15/08; F16H 7/0831; F16H 2007/081; F16H 2007/0842; F16H 2007/0865; F16H 2007/0874; F16H 2007/0893

(57) ABSTRACT

To obtain maximum performance and belt longevity, it is important that the belt is properly tensioned. In some scenarios such as hybrid vehicles where the belt is going through large variations in drive torque due to varying Belt Starter Generator (BSG) parameters due to regeneration and the like, a dynamic pivot may optimize belt tension for a variety of engine modes. In some embodiments a dynamic pivot dual arm tensioner may include a center arm having a first tensioning pulley journaled to the center arm and engageable with a mounting surface, such as an engine block or accessory bracket, through a mounting axis; a side arm having a second tensioning pulley journaled to the side arm and coupled to the center arm; a dynamic pivot around which the tensioner dynamically rotates; and the dynamic pivot journaled to the center arm.

This application claims priority to U.S. Provisional Patent Application No. 63/408,248 , filed Sep. 20, 2022, the entirety of which is hereby incorporated by reference.

### TECHNICAL FIELD

The present invention relates to a dynamic pivot dual arm belt tensioner for hybrid and conventional drive systems.

### BACKGROUND

The present disclosure is directed to belt tensioners such as for use with hybrid vehicles, and other systems that utilize a dual arm tensioner such as in the conventional automotive and transportation industries. Applications that use a belt often require the use of a belt tensioner to ensure desired performance. Dual arm tensioners may have significant advantages over a single tensioner in that hubload forces may be decreased and more control over belt slip may be available. Modern engines with a starter-generator unit have been developed to improve fuel consumption and emissions.

The tensioners of this disclosure are particularly suited for optimizing belt tension under varying engine modes, improving belt life, reducing noise generation, and improving overall system efficiency. The dual arm tensioner may include a dynamic pivot to aid in accomplishing this. Including a dynamic pivot may be beneficial in providing optimal belt tension at varying engine modes such as, but not limited to, Belt Starter Generator (BSG) start-up, recuperation, generation, shutdown, braking, boost, etc. As hybrid and conventional motors increase in complexity, so do the new generation of dual arm tensioners. With increasing complexity and an increase in the number of parts, it may initially be difficult to find a good location for the tensioner's center arm pivot without one of the arms or pulleys colliding with other accessories or resulting in issues such as but not limited to small, non-optimal wrap angles around the pulleys, high levels of vibration on segments of the belt, belt slip, and/or low belt tension under at least one of the several engine modes available in current automotive applications. Currently, the solution to these problems is to find a location, through testing, where none of the engine modes are optimal, which means compromising performance. The present invention integrates an eccentricity to the axis of rotation of the tensioner's center arm by utilizing a dynamic pivot, which may allow optimal belt tension under multiple and varying engine modes.

Generally, an engine with a starter-generator unit has been developed to improve the fuel consumption and emissions of modern vehicles. When the starter-generator unit in this type of engine is activated, it acts as a starter motor to restart the engine. Once the engine is started, the starter-generator unit can be used as a generator to recharge the battery.

The starter-generator unit is mechanically connected to a crankshaft of the engine through a circular transmission apparatus, such as a belt or chain. The circular transmission apparatus vibrates under the influence of the system, especially when the starter-generator unit switches functions between the starter and the generator. In such an event, the roles of the tensioned and relaxed sides of the circular transmission apparatus are exchanged with each other. For this reason, the industry has developed a tensioner to handle the vibration of the circular transmission apparatus with the starter-generator unit.

For specific tensioners, refer to the tensioner structures disclosed by and herein incorporated by reference, U.S. Pat. Nos. 7,637,829, 9,341,243, 9,651,122, EP2384272B1, WO2021/093836, and the like.

### SUMMARY

In one embodiment of a dynamic pivot dual arm tensioner, there may be a bushing with variable thickness so that two pivot centers exist in the same bushing. One of the pivot centers may be the center of the inner diameter of the bushing. In some embodiments, it may be beneficial for this pivot center to be stationary or fixed. And in another embodiment, a second pivot center may be the center of the outer diameter of the bushing. In some embodiments, it may be beneficial for the second pivot center to be dynamic, depending on the hubload angle exerted on the pulleys created by the varying belt loads. In some embodiments, the dynamic pivot may have a different position for each varying engine mode. This may be because the hubload angle varies depending on the torque generated or used by a BSG.

Utilizing two pivot centers, a stationary and dynamic pivot, may be beneficial in certain embodiments because after finding the ideal location of the tensioner's pivot for each engine mode the level of bushing eccentricity and necessary layout of the dual arm tensioner may be more optimally determined. This optimization may include but is not limited to moving the dynamic pivot closer to the ideal tensioner location for each engine mode or to precisely position the dynamic pivot at those ideal positions for every BSG torque level.

In some embodiments, optimizing the position of the dynamic may be beneficial in maximizing wrap angle in the varying engine modes, minimizing belt slip on the pulleys, minimizing belt vibration, minimizing the variation in belt tension, and minimizing the variation of pulley hubloads. By optimizing these parameters, the durability and longevity of the belt, pulleys, and tensioner damping elements may be increased. In some embodiments, an increase in vehicle performance may also be seen.

For a specific pulley layout for every engine mode, there is an ideal position for the tensioner's pivot to be located. In some embodiments that ideal position may be the position where the wrap angle around the pulleys is maximized and belt slip, belt vibration, belt tension variation and hubload variation are minimized. In some embodiments, the tensioner's center arm may rotate around the dynamic pivot, instead of the fixed pivot found in the current state-of-the-art dual arm tensioners.

Some beneficial effects of the present invention may be that the dual arm tensioner has a simple structure and is easy to assemble while also being able to provide the optimal belt tension for varying engine modes.

Additionally, or alternately, the tensioner may have at least two arms dynamically rotatable around a dynamic pivot. A dynamic pivot may include, but is not limited to, a center arm journaled to a first tensioning pulley, a side arm journaled to a second tensioning pulley, the side arm coupled to the center arm; and the center arm pivotable around a dynamic pivot. Other embodiments are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is an exemplary isometric view of a dynamic pivot dual arm tensioner.

FIG. 2 is an exemplary top view of a dynamic pivot dual arm tensioner.

FIG. 3 is an exemplary cross-sectional view of a dynamic pivot dual arm tensioner along plane A-A.

FIG. 4 is an exemplary embodiment of a first engine mode.

FIG. 5 is an exemplary embodiment of a second engine mode.

FIG. 6 is an exemplary embodiment of a third engine mode.

FIG. 7 is an exemplary embodiment of a fourth engine mode.

### DETAILED DESCRIPTION

As described above, described herein are dual arm belt tensioners utilizing a dynamic pivot for optimized belt and pulley dynamics under varying engine mode torques.

In the following description, reference is made to the accompanying drawing that forms a part hereof and in which is shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

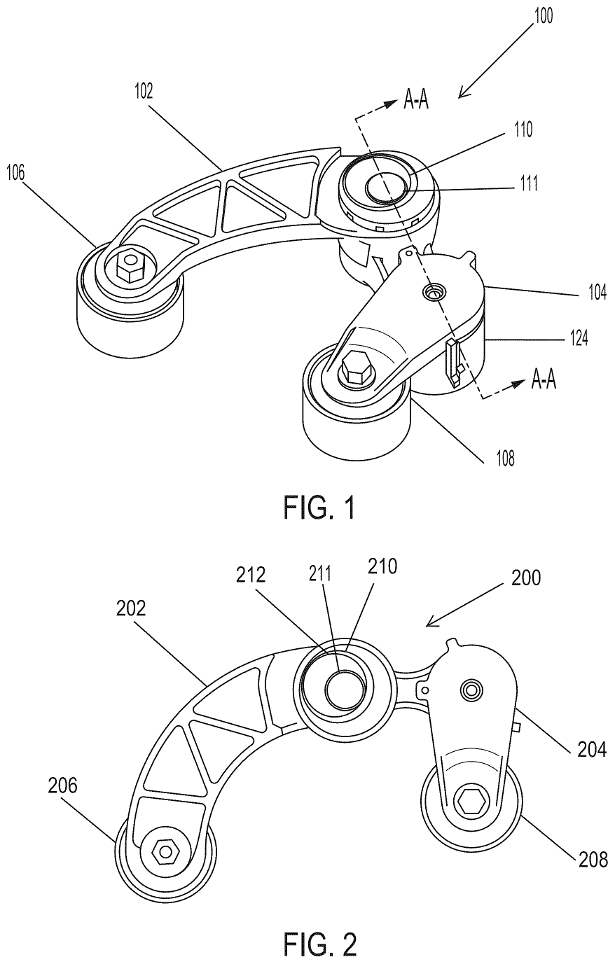

FIG. 1 is an exemplary illustration of a dynamic pivot dual arm tensioner. FIG. 1 shows a dynamic pivot dual arm tensioner 100 according to this disclosure. In some embodiments, the dynamic pivot dual arm tensioner 100 may include but is not limited to a center arm 102 journaled to a first tensioning pulley 106, a side arm 104 journaled to a second tensioning pulley 108, the side arm coupled to the center arm; the center arm pivotable around a dynamic pivot 110, and a carrier member 124 to house side arm tensioning members. In some embodiments, the center arm 102 may be made from stamped metal, engineering-grade polymers, composites, or the like. The center arm 102 may be manufactured by stamping, machining, casting, or by a combination of processes. In some embodiments, the side arm 104 may be made from stamped metal, engineering-grade polymers, composites, or the like. The side arm 104 may be manufactured by stamping, machining, casting, a combination of processes, or the like. In the aforementioned embodiments, with reference to FIG. 1, the center arm 102 is provided on the left side of the motor generator unit and the side arm 104 is provided on the right side thereof. In other embodiments, the center arm 102 may be provided on the right side of the motor generator unit, and the side arm 104 may be provided on the left side thereof, i.e. the left and right positions of the center arm and side arm may be exchanged with each other. In some embodiments, the side arm 104 may be coupled to the center arm 102 through the use of a fixing member such as but not limited to a fastener, snap fitting, or the like. In some embodiments, a torsion spring may be disposed between the side arm 104 and the center arm 102 axially around the fastener or fastening member. In some embodiments, the side arm 104 may include a carrier member 124 having a frictional surface that engages the torsion spring with a surface on the center arm 102 and having a frictional surface engagement with the side arm 104 to damp an oscillatory movement of the side arm. In some embodiments, the center arm may be dynamically pivotable around a dynamic pivot. A dynamic pivot 110 may be an eccentric bearing that allows the hubloads of varying engine modes to be in optimized positions.

Usually, one or more accessory pulleys may be provided as required between the crankshaft pulley and the motor generator unit pulley. When the accessory pulleys are provided, the first and second transmission parts may be cross portions between the motor generator unit pulley and the accessory pulleys, respectively. The first transmission part is on the left side of the motor generator unit pulley, and the second transmission part is on the right side of the motor generator unit pulley. In some embodiments, the dynamic pivot dual arm tensioner 100 may include an arc-shaped center arm to allow the dynamic pivot dual arm tensioner 100 to not interfere with a motor generator pully or another accessory pulley.

In one embodiment, the center arm 102 is provided with a dynamic pivot center bore 111 through the dynamic pivot 110, and the side arm 104 is secured on the internal combustion engine and dynamic pivot dual arm tensioner 100 pivotally by using a fixing member (not shown in figures) configured to secure the dynamic pivot dual arm tensioner 100 to the engine block or other mounting surface. The fixing member may be in various forms. For example, it may be provided as a bolt, a pin, or a snap fastener. In some embodiments, an antifriction member such as a lining or bearing with a low friction coefficient may be provided between the fixing member and the dynamic pivot center bore (shown in FIG. 2 as 211), so that the side arm 104 of the dynamic pivot dual arm tensioner 100 can pivot freely on the internal combustion engine. In addition, the antifriction member may provide a certain degree of damping to relieve the relative movement of the center arm and the fixing member.

In some embodiments of a dynamic pivot dual arm tensioner 100, it may be beneficial to include a center arm having a first tensioning pulley 106 journaled to the center arm 102 and engageable with a mounting surface, such as an engine block or accessory bracket, through a mounting axis; a side arm 104 having a second tensioning pulley 108 journaled to the side arm 104 and coupled to the center arm 102, through the use of a pin, snap fit, bolt, tensioning member, or the like; a dynamic pivot 110 around which the dynamic pivot dual arm tensioner 100 dynamically rotates; and the dynamic pivot 110 journaled to the center arm 102. In some embodiments the first and second tensioning pulley 106, 108 may be made from a metal alloy, polymer, composite material, or the like.

In some embodiments, the dynamic pivot 110 may comprise an eccentric bushing that may allow at least two variable and/or dynamic pivot centers. In some embodiments to assist with proper belt tension, a torsion spring may be displaced between the side arm 104 and the center arm 102. In some embodiments, the torsion spring may be enclosed in a carrier member 124 that also may include a frictional surface that engages a surface on the center arm and has a frictional engagement with the side arm to damp oscillatory movement of the side arm. A damping member may also be included which may be an engineering-grade polymer, polymer, or composite-pad, shoe, or the like.

In some embodiments, it may be beneficial to further include a fixing member for positively securing the dynamic pivot dual arm tensioner 100 to a motor generator, engine block, accessory bracket, or the like. The fixing member may be a bolt configured and arranged to pass through a dynamic pivot center bore aligned to the mounting axis of the dynamic pivot 110 to fix the dynamic pivot dual arm tensioner 100 to a motor generator. The fixing member may also be a pin, snapping member, or the like.

In another embodiment of a dynamic pivot dual arm tensioner 100, it may be beneficial to include a center arm having a first tensioning pulley journaled to the center arm and engageable with a mounting surface, such as an engine block or accessory bracket, through a mounting axis; a side arm 104 having a second tensioning pulley 108 journaled to the side arm 104 and coupled to the center arm 102, through the use of a pin, snap fit, bolt, tensioning member, or the like; a dynamic pivot around which the tensioner dynamically rotates, wherein the dynamic pivot 110 is an eccentric bushing; and the dynamic pivot journaled to the center arm.

In some embodiments, the dynamic pivot 110 may comprise an eccentric bushing that may allow at least two variable and/or dynamic pivot centers. In some embodiments to assist with proper belt tension, a torsion spring may be displaced between the side arm and the center arm. In some embodiments, the torsion spring may be enclosed in a carrier member 124 that also may include a frictional surface that engages a surface on the center arm 102 and has a frictional engagement with the side arm to damp oscillatory movement of the side arm. A damping member may also be included which may be an engineering-grade polymer or composite pad, shoe, or the like.

In some embodiments, it may be beneficial to further include a fixing member for positively securing the dynamic pivot dual arm tensioner 100 to a motor generator, engine block, accessory bracket, or the like. The fixing member may be a bolt configured and arranged to pass through a dynamic pivot center bore aligned to the mounting axis of the dynamic pivot 110 to fix the dynamic pivot dual arm tensioner to a motor generator. The fixing member may also be a pin, snapping member, or the like.

FIG. 2 is an exemplary top view of a dynamic pivot dual arm tensioner. In some embodiments, the dynamic pivot dual arm tensioner 200 may include but is not limited to a center arm 202 journaled to a first tensioning pulley 206, a side arm 204 journaled to a second tensioning pulley 208, the side arm coupled to the center arm; and the center arm pivotable around a dynamic pivot 210. In some embodiments, the dynamic pivot may include an eccentric bushing 212 with a dynamic pivot center bore 211 that allows varying levels of eccentricity depending on the geometry of the bushing. The dynamic pivot center bore 211 may also allow the dynamic pivot dual arm tensioner 200 to be secured to the engine block, accessory bracket, or motor generator by a fixing member such as a bolt, pin, or snap member. In some embodiments, a snapping member may be a detent in the geometry of the center arm that allows the dynamic pivot dual arm tensioner 200 to be removably locked into the engine block, accessory bracket, or motor generator. A snapping member may also be a locking clip, locking tabs, or the like.

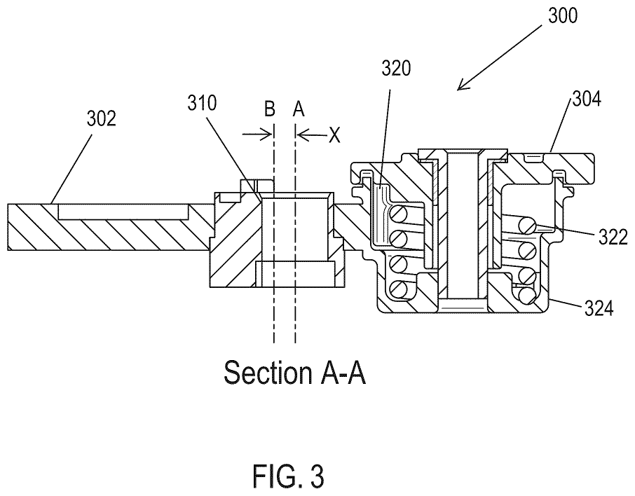

FIG. 3 is an exemplary cross-sectional view of a dynamic pivot dual arm tensioner along plane A-A. In some embodiments, the dual arm tensioner center of rotation axis A has eccentrically displaced a distance “X” from the axis of rotation B of the dynamic pivot. Distance “X” is determinative of the level of eccentricity as the dynamic pivot dual arm tensioner 300 is pivoted about axis A. Dynamic pivot center bore 211 is aligned with axis A. In some embodiments, dynamic pivot dual arm tensioner 300 may include a center arm 302, a dynamic pivot 310, a second tensioning pulley 308, a damping member 320 which may be an antifriction member damping mechanism, a side arm 304, and a tensioning member 322. In some embodiments, the damping member 320 may also be provided between a carrier member 324 and the side arm 304, so that the side am 304 better biases the dynamic pivot 310, and the vibration of the dynamic pivot 310 is relieved. Typically, the damping member 320 may abut against the end portion of the tensioning member 322 that may be a torsion spring, to be connected in series; or the damping member 320 may be connected in parallel with the torsion spring. Certainly, other forms can also be used.

In some embodiments, a disc spring (not illustrated) may also be provided on the dynamic pivoting center around the dynamic pivot center bore. The disc spring may be axially provided between the fixing member and the center arm, providing an axial pressure on the dynamic pivoting center and increasing the damping of the dynamic pivoting center around the dynamic pivot center bore.

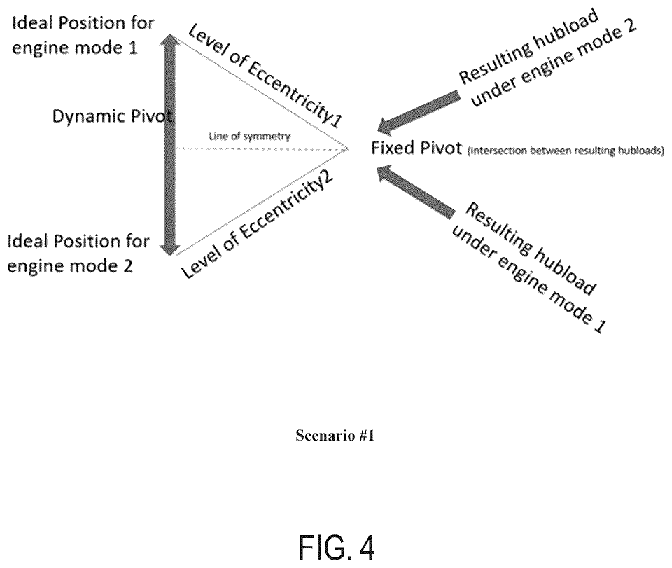

FIG. 4 is an exemplary embodiment of a first engine mode. In one embodiment a first engine mode may be an engine mode such as, but not limited to, start-up, Belt Starter Generator (BSG) start-up, recuperation, generation, shutdown, braking, boost, etc. Each mode may have an ideal tensioner position. In one embodiment it may be beneficial to place the fixed pivot's position (the center of the inner diameter of the busing) may be placed at the approximate intersection (or the exact intersection if each intersects at an exact point) of the resulting hubload of the two desired engine modes to be optimized. For the engine modes to be optimized using a singular component it may be necessary to have the intersection for the resulting hubloads intersect the line of symmetry. The line of symmetry may be an imaginary line perpendicular to the line connecting the most extreme ideal tensioner positions. Multiple engine modes may be used to calculate the ideal tensioner position. Depending on the resulting hubloads of the belt drive system, the level of eccentricity to optimize the dynamic pivot may be calculated.

In one embodiment when calculating the required amount of eccentricity necessary for a specific dynamic pivot for a specific application the resulting hubloads may be pointing towards their corresponding ideal position. In this embodiment, the angle between resulting hubloads is considerable, which may result in small levels of eccentricity required. In this embodiment, the resulting hubloads are equal with equal angles from the line of symmetry and therefore result in identical levels of eccentricity for each engine mode.

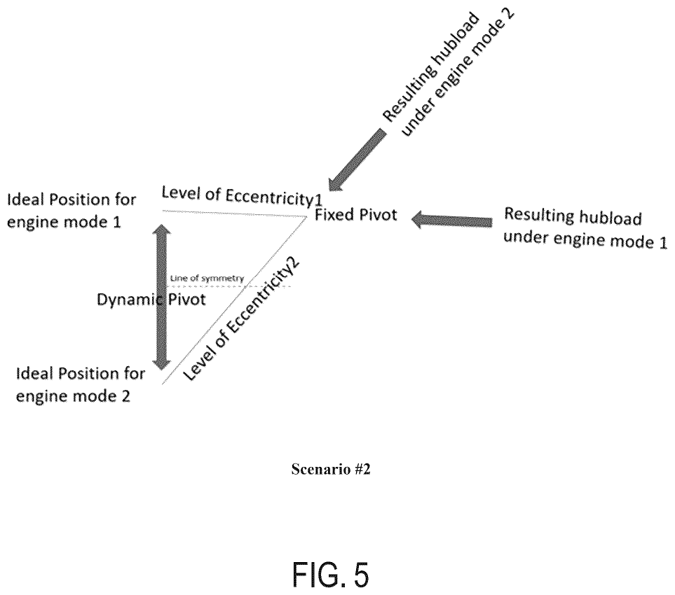

FIG. 5 is an exemplary embodiment of a second engine mode. In another embodiment a second engine mode may be an engine mode such as, but not limited to, start-up, Belt Starter Generator (BSG) start-up, recuperation, generation, shutdown, braking, boost, etc. Each mode may have an ideal tensioner position. In some embodiments, depending on the resulting hubloads, the resulting hubloads may still be pointing towards their corresponding ideal positions but the angle between the hubloads may be smaller resulting in smaller levels of eccentricity. However, in this embodiment, the resulting hubloads are not equal around the line of symmetry and therefore the ideal level of eccentricity for each engine mode may not be obtainable. In this embodiment different levels of eccentricity are required for each engine mode. In such an instance the most optimal solution would be to move the position of the dual arm tensioner to bring the resulting hubloads and angles closer to equal, so the levels of eccentricity are closer to equal.

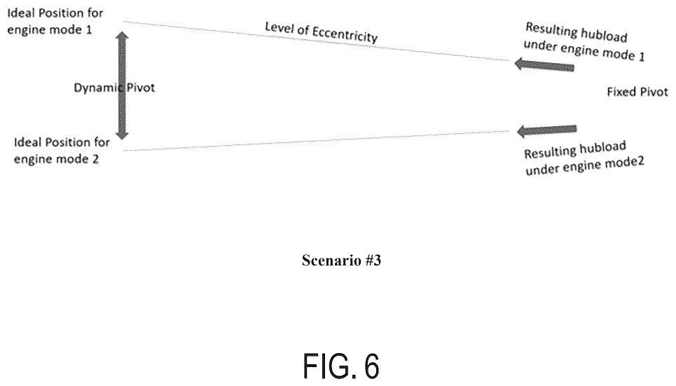

FIG. 6 is an exemplary embodiment of a third engine mode. In another embodiment, not an ideal scenario the resulting hubloads may not intersect. The resulting hubload vectors are still pointing toward their ideal position but the angle between the resulting hubloads is too small which results in large levels of eccentricity which may not be able to be accounted for with tensioner packaging requirements. However, if there are no packaging constraints such as with a large industrial motor large levels of eccentricity may be able to be accounted for with large dynamic pivots.

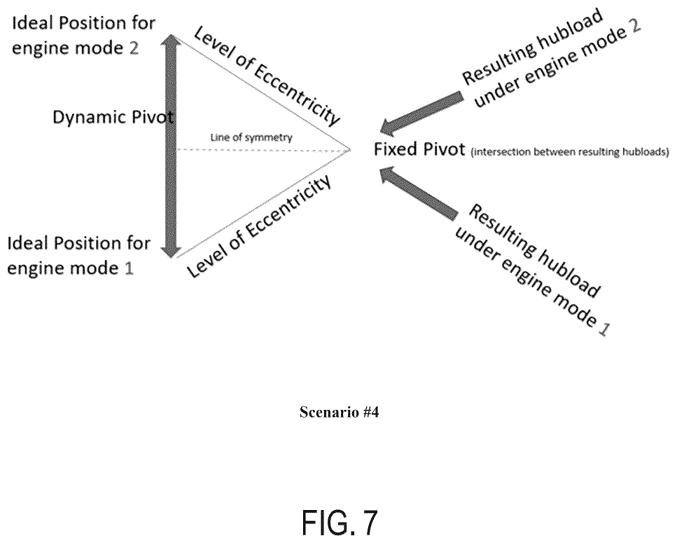

FIG. 7 is an exemplary embodiment of a fourth engine mode. In another embodiment, the angle between the resulting hubloads is considerable, resulting in small levels of eccentricity. The resultant hubload vectors may also be symmetrical around the line of symmetry which is an ideal scenario to have equal levels of eccentricity for each varying engine mode. However, as illustrated in FIG. 7 the resultant hubload vectors are not pointing towards each's respective ideal position which may create mismatched positions for the ideal position and the position of the dynamic pivot under each engine mode. In this scenario, it may be most beneficial to modify the layout of the tensioner system and belt layout to move the resulting hubloads within their ideal positions.

The above specification and examples provide a complete description of the structure and use of exemplary embodiments of the invention. The above description provides specific embodiments. It is to be understood that other embodiments are contemplated and may be made without departing from the scope or spirit of the present disclosure. The above-detailed description, therefore, is not to be taken in a limiting sense. For example, elements or features of one example, embodiment or implementation may be applied to any other example, embodiment or implementation described herein to the extent such contents do not conflict. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a,” “an,” and “the” encompass implementations having plural referents, unless the content clearly dictates otherwise. As used in this specification and the appended claims, the term “or” is generally employed in its sense including “and/or” unless the content clearly dictates otherwise.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

What is claimed is:

1. A tensioner comprising:
a center arm having a first tensioning pulley journaled thereto and engageable with a mounting surface through a mounting axis;
a side arm having a second tensioning pulley journaled thereto and coupled to the center arm;
a dynamic pivot around which the tensioner dynamically rotates; and
the dynamic pivot journaled to the center arm.

2. The tensioner of claim 1, wherein the dynamic pivot comprises an eccentric bushing.

3. The tensioner of claim 1, further comprising a torsion spring disposed between the side arm and the center arm.

4. The tensioner of claim 3 further comprising:
a carrier member having a frictional surface that engages a surface on the center arm, and having a frictional surface engagement with the side arm to damp an oscillatory movement of the side arm.

5. The tensioner of claim 1, wherein the center arm is stamped.

6. The tensioner of claim 1, wherein the center arm is cast.

7. The tensioner of claim 1, wherein the side arm is stamped.

8. The tensioner of claim 1, wherein the side arm is cast.

9. The tensioner of claim 1, further comprising a fixing member.

10. The tensioner of claim 9, wherein the fixing member comprises a bolt configured and arranged to pass through a dynamic pivot center bore aligned to the mounting axis of the dynamic pivot to fix the tensioner to a motor generator.

11. A tensioner comprising:
a center arm having a first tensioning pulley journaled thereto and engageable with a mounting surface through a mounting axis;
a side arm having a second tensioning pulley journaled thereto and coupled to the center arm;
a dynamic pivot around which the tensioner dynamically rotates, wherein the dynamic pivot comprises an eccentric bushing; and
the dynamic pivot journaled to the center arm.

12. The tensioner of claim 11, further comprising a torsion spring disposed between the side arm and the center arm.

13. The tensioner of claim 12 further comprising:
a carrier member having a frictional surface that engages a surface on the center arm, and having a frictional surface engagement with the side arm to damp an oscillatory movement of the side arm.

14. The tensioner of claim 11, wherein the center arm is stamped.

15. The tensioner of claim 11, wherein the center arm is cast.

16. The tensioner of claim 11, wherein the side arm is stamped.

17. The tensioner of claim 11, wherein the side arm is cast.

18. The tensioner of claim 11, further comprising a fixing member.

19. The tensioner of claim 18, wherein the fixing member comprises a bolt configured and arranged to pass through a dynamic pivot center bore aligned to the mounting axis of the dynamic pivot to fix the tensioner to a motor generator.
